(19) United States
(12) Patent Application Publication
(10) Pub. No.: US 2015/0077672 A1
(43) Pub. Date: Mar. 19, 2015

(54) LIQUID CRYSTAL DISPLAY

(71) Applicant: Samsung Display Co., Ltd., Yongin-city (KR)

(72) Inventors: Soon Joon RHO, Suwon-si (KR); Kyung Min KIM, Seoul (KR); Jin-Lak KIM, Osan-si (KR); Hye Lim JANG, Yongin-si (KR); Keun Chan OH, Cheonan-si (KR)

(73) Assignee: Samsung Display Co., Ltd., Yongin-city (KR)

(21) Appl. No.: 14/259,742

(22) Filed: Apr. 23, 2014

(30) Foreign Application Priority Data
Sep. 13, 2013 (KR) 10-2013-0110683

(51) Int. Cl. G02F 1/1343

(52) U.S. Cl. CPC G02F 1/13439
USPC 349/42

(57) ABSTRACT

Disclosed is a liquid crystal display including: a first substrate; a second substrate facing the first substrate; a thin film transistor disposed on the first substrate; a pixel electrode connected to the thin film transistor and including a first subpixel electrode and a second subpixel electrode; a common electrode disposed on the second substrate; and a liquid crystal layer disposed between the first substrate and the second substrate, and including liquid crystal molecules therein. The first and second subpixel electrodes include a cross-shaped stem portion including horizontal and vertical stem portions, and a plurality of micro-branch portions extending from the cross-shaped stem portion, a thickness of the liquid crystal layer being 2.4 μm to 3.2 μm, the dielectric anisotropy of the liquid crystal molecule being −3.0 to −2.0, and a pitch of the micro-branch portion being 4 μm to 6 μm.

### CROSS-REFERENCE TO RELATED APPLICATION

This application claims priority from and the benefit of Korean Patent Application No. 10-2013-0110683, filed on Sep. 13, 2013, which is hereby incorporated by reference for all purposes as if fully set forth herein.

### BACKGROUND

1. Technical Field

Exemplary embodiments of the present disclosure relate to a liquid crystal display.

2. Discussion of the Background

A liquid crystal display, which is one of the most widely-used flat panel display types, typically includes two panels on which electric field generating electrodes, such as a pixel is electrode and a common electrode, are formed, and a liquid crystal layer inserted therebetween.

A liquid crystal display generally displays an image by creating an electric field on the liquid crystal layer by applying voltage to the electric field generating electrodes, determining the alignments of the liquid crystal molecules included in the liquid crystal layer by the created electric field, and thereby controlling the polarization of incident light.

Among liquid crystal displays, vertical-alignment type of displays are particularly drawing attention. In the vertical alignment type, the long axes of the liquid crystal molecules are arranged to be vertical to the upper and lower panels in the state where an electric field is not applied, and thus that type of displays tend to achieve high contrast ratios and wide reference viewing angles.

In order to realize wide viewing angles in a liquid crystal display of the vertical-alignment type, a plurality of domains having different alignment directions of liquid crystals may be formed in one pixel.

As an exemplary means for forming a plurality of domains in one pixel, a method of forming a cutout, such as a micro-slit, in an electric field generating electrode, or a method of forming a protrusion on the electric field generating electrode is used. According to these methods, the liquid crystals are aligned in a direction vertical to a fringe field by its field effect. The fringe field is formed between an edge of the cutout or the protrusion and the electric field generating electrode facing the edge of the cutout or the protrusion, so that the plurality of domains may be formed.

Meanwhile, for rapid driving of a liquid crystal display, liquid crystals have been developed to achieve a high response speed of the liquid crystals, and high-speed driving may be implemented by decreasing the cell gap, that is, the thickness of the liquid crystal layer.

However, when the thickness of the liquid crystal layer is decreased, the fringe field may become intense, which may result in deterioration of the transmittance of the display.

The above information disclosed in this Background section is only for enhancement of understanding of the background of the invention and therefore it may contain information that does not form the prior art that is already known to a person of ordinary skill in the art.

### SUMMARY

Various exemplary embodiments of the present invention have been proposed in an effort to improve transmittance of a liquid crystal display in which a plurality of micro-branch portions is formed in an electric field generating electrode.

An exemplary embodiment of the present invention provides a liquid crystal display, including: a first substrate; a second substrate facing the first substrate; a thin film transistor disposed on the first substrate; a pixel electrode connected to the thin film transistor and including a first subpixel electrode and a second subpixel electrode that are separate from each other; a common electrode disposed on the second substrate; and a liquid crystal layer disposed between the first substrate and the second substrate and including liquid crystal molecules having negative dielectric anisotropy, in which the first subpixel electrode and the second subpixel electrode include a cross-shaped stem portion including a horizontal stem portion and a vertical stem portion crossing the horizontal stem portion, and a plurality of micro-branch portions extending from the cross-shaped stem portion, a thickness of the liquid crystal layer is 2.4 μm to 3.2 μm, the dielectric anisotropy of the liquid crystal molecule is −3.0 to −2.0, and a pitch of the micro-branch portion is 4 μm to 6 μm.

According to various exemplary embodiments of the present invention, transmittance can be improved by adjusting the thickness of the liquid crystal layer, the dielectric anisotropy of liquid crystals, and the pitch of the micro-branch portion.

Further, transmittance can be improved by adjusting the width of a micro-branch and a micro-slit configuring a micro-branch portion.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a layout view illustrating a liquid crystal display according to an exemplary embodiment of the present invention.

FIG. 2 is a cross-sectional view taken along cut line II-II of FIG. 1.

FIG. 3 is a cross-sectional view taken along cut line III-III of FIG. 1.

FIG. 4 is an enlarged view of region A of FIG. 1.

FIG. 5 is a graph illustrating a relationship between a cell gap, a pitch of a micro-branch portion, and dielectric anisotropy of a liquid crystal and transmittance when the ratio of the width of a micro-branch to the width of a micro-slit configuring a pitch of the micro-branch portion is 1:1.

FIG. 6 is a graph illustrating a relationship between a cell gap, a pitch of a micro-branch portion, and dielectric anisotropy and transmittance of liquid crystal according to the width of a micro-branch to the width of a micro-slit configuring a pitch of the micro-branch portion.

FIG. 7 is a layout view illustrating a liquid crystal display according to another exemplary embodiment of the present invention.

FIG. 8 is a cross-sectional view taken along cut line VIII-VIII of FIG. 4.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In addition, the size and thickness of each configuration shown in the drawings are arbitrarily shown for understanding and ease of description, but the present invention is not limited thereto.

In the drawings, the thickness of layers, films, panels, regions, etc., are exaggerated for clarity. In the drawings, for understanding and ease of description, the thickness of some layers and areas is exaggerated. It will be understood that when an element such as a layer, film, region, or substrate is referred to as being “on” or “connected to” another element, it can be directly on the other element or intervening elements may also be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

In addition, unless explicitly described to the contrary, the word “comprise” and variations such as “comprises” or “comprising,” will be understood to imply the inclusion of stated elements but not the exclusion of any other elements. Further, in the specification, the word “on” means positioning on or below the object portion, but does not essentially mean positioning on the upper side of the object portion based on a gravity direction.

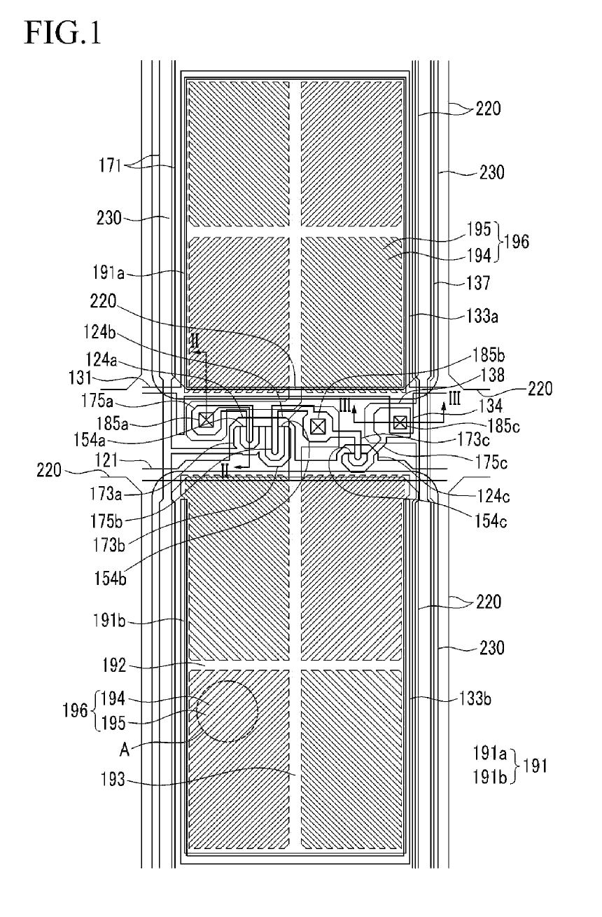

A liquid crystal display according to an exemplary embodiment of the present invention will be described with reference to FIGS. 1 to 4.

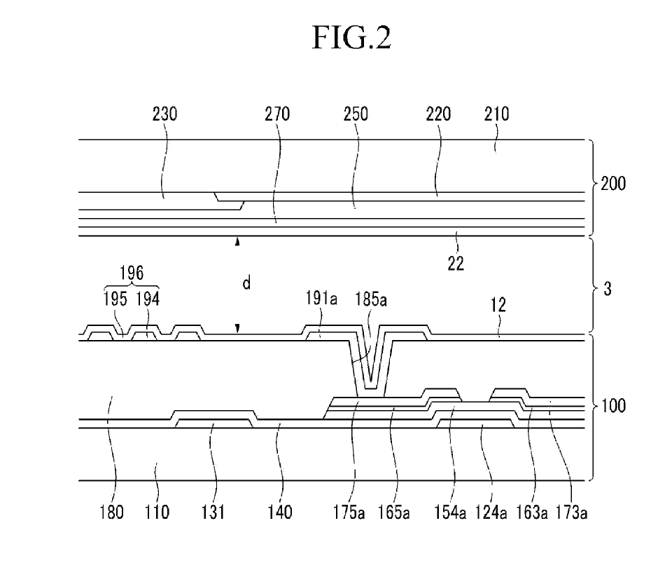

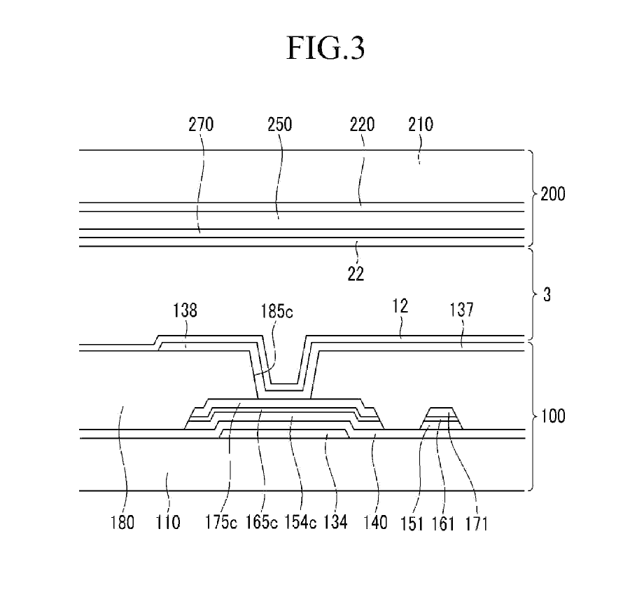

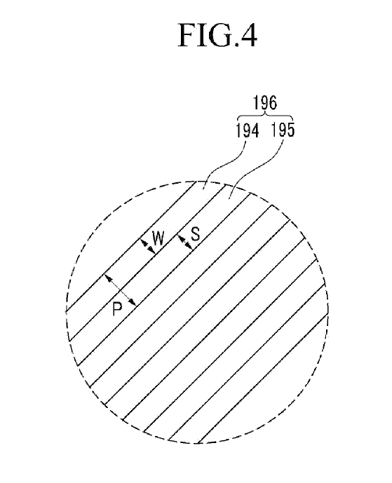

FIG. 1 is a layout view illustrating a liquid crystal display according to an exemplary embodiment of the present invention, and FIG. 2 is a cross-sectional view taken along cut line II-II of FIG. 1. Further, FIG. 3 is a cross-sectional view taken along cut line III-III of FIG. 1, and FIG. 4 is an enlarged view of region A of FIG. 1.

Referring to FIGS. 1 to 3, a liquid crystal display according to one exemplary embodiment includes a first panel 100 and a second panel 200, which face each other, and a liquid crystal layer 3 interposed between the first and second panels 100 and 200.

A cell gap d, which represents the thickness of the liquid crystal layer 3 interposed between the first panel 100 and the second panel 200, is determined appropriately and may be, for example, in a range of 2.4 μm to 3.2 μm.

In accordance with one exemplary embodiment, the liquid crystal layer 3 may include liquid crystal molecules having negative dielectric anisotropy, and the liquid crystal molecules may be aligned so that the long axes thereof are vertical to the surfaces of the first and second panels 100 and 200 in the state where there is no electric field.

The dielectric anisotropy (Δε) of the liquid crystal molecule may be, for example, −3.0 to −2.0.

Hereinafter, the first panel 100 is described.

In accordance with one exemplary embodiment, gate lines 121 and reference voltage lines 131 may be formed on a first substrate 110 which may be made of transparent glass or plastic, for example.

A gate line 121 may mainly extend in the horizontal direction to transfer a gate signal and may be formed integrally or connected with a first gate electrode 124a, a second gate electrode 124b, and a third gate electrode 124c.

A reference voltage line 131 may mainly extend in the horizontal direction to transfer a predetermined voltage, such as a reference voltage, and may be connected or formed integrally with a first reference electrode 133a surrounding a first subpixel electrode 191a, as described below in more detail. The reference voltage line 131 may also be connected with or formed integrally with a protruding portion 134 protruding toward the gate line 121. Further, a second reference electrode 133b surrounding a second subpixel electrode 191b, as described below, is disposed. Although not illustrated in FIG. 1, a horizontal portion of the first reference electrode 133a may be connected with a horizontal portion of the second reference electrode 133b, for example, as an integrated wire.

In accordance with one exemplary embodiment, a gate insulating layer 140 may be formed on the gate lines 121 and the reference voltage lines 131.

Further, a first semiconductor 154a, a second semiconductor 154b, and a third semiconductor 154c may be formed on the gate insulating layer 140

A plurality of ohmic contacts may be formed on the first semiconductor 154a, the second semiconductor 154b, and the third semiconductor 154c. For example, ohmic contacts 163a and 165a are formed on the first semiconductor 154a as illustrated in FIG. 2, and an ohmic contact 165c is formed on the third semiconductor 154c as illustrated in FIG. 3. One of ordinary skill in the art will readily appreciate that additional ohmic contacts may be formed on the second semiconductor 154b.

In accordance with one exemplary embodiment, data conductors, which include a plurality of data lines 171, a first drain electrode 175a, a second drain electrode 175b, a third source electrode 173c, and a third drain electrode 175c, may be formed on the ohmic contact 163a, 165a, and 165c and the gate insulating layer 140. In one example, the plurality of date lines 171 may be connected or integrally formed with a first source electrode 173a and a second source electrode 173b. Also, the third drain electrode 175c may overlap the protruding portion 134 of the reference voltage line 131.

The first gate electrode 124a, the first source electrode 173a, and the first drain electrode 175a may form a first thin film transistor together with the first semiconductor 154a, and the channel of the first thin film transistor is formed in the semiconductor portion 154a between the first source electrode 173a and the first drain electrode 175a.

Similarly, the second gate electrode 124b, the second source electrode 173b, and the second drain electrode 175b form a second thin film transistor together with the second semiconductor 154b, so that the channel of the second thin film transistor is formed in the semiconductor portion 154b between the second source electrode 173b and the second drain electrode 175b. Further, the third gate electrode 124c, the third source electrode 173c, and the third drain electrode 175c form a third thin film transistor together with the third semiconductor 154c, so that the channel of the third thin film transistor is formed in the semiconductor portion 154c between the third source electrode 173c and the third drain electrode 175c.

In addition, a passivation layer 180 may be formed on the data conductors 171, 173c, 175a, 175b, and 175c and the exposed portions of the semiconductors 154a, 154b, and 154c. The passivation layer 180 may be formed of an organic insulating material, for example, and the surface thereof may be flat.

Further, the passivation layer 180 may have a dual layer structure including a lower inorganic layer and an upper organic layer, so that the inorganic layer mainly prevents the exposed portions of the semiconductors 154a, 154b, and 154c from being damaged while the upper organic layer contributes to excellent insulation characteristics of the passivation layer 180.

In addition, a first contact hole 185a, a second contact hole 185b, and a third contact hole 185c through which the first drain electrode 175a, the second drain electrode 175b, and the third drain electrode 175c are exposed, respectively, may be formed in the passivation layer 180.

In accordance with one exemplary embodiment, a pixel electrode 191 including a first subpixel electrode 191a and a second subpixel electrode 191b, and an auxiliary voltage line 137 may be formed on the passivation layer 180. The pixel electrode 191 and the auxiliary voltage line 137 may be formed, for example, of a transparent conductive material, such as ITO or IZO, or reflective metal, such as aluminum, silver, chromium, and an alloy thereof

With respect to the pixel electrode 191, the first subpixel electrode 191a and the second subpixel electrode 191b may be formed adjacent to each other in the column direction, having a quadrangular shape overall, and may include a cross-shaped stem portion including a horizontal stem portion 192 and a vertical stem portion 193 crossing the horizontal stem portion 192.

Further, the first subpixel electrode 191a and the second subpixel electrode 191b may be divided into multiple sub-regions, such as four sub-regions, by the horizontal stem portion 192 and the vertical stem portion 193, and each sub-region may include a plurality of micro-branch portions 196. Each micro-branch portion 196 may include a micro-branch 194 and a micro-slit 195.

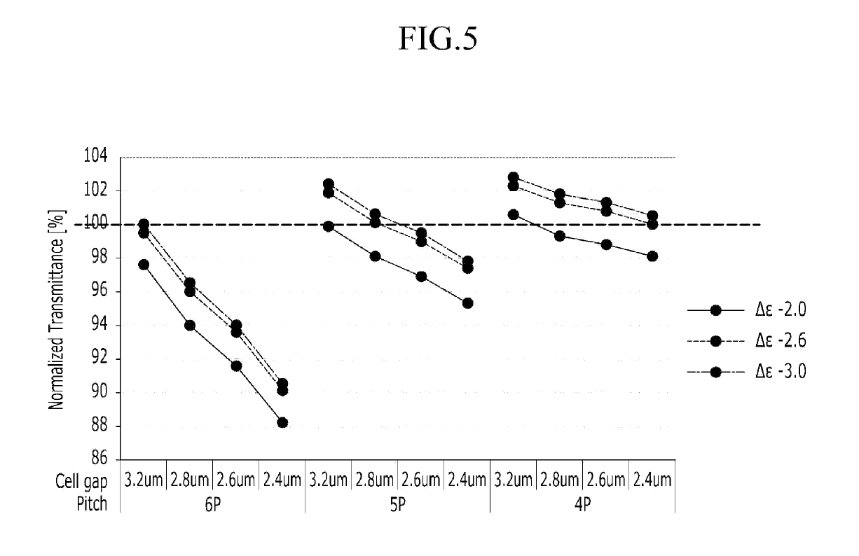

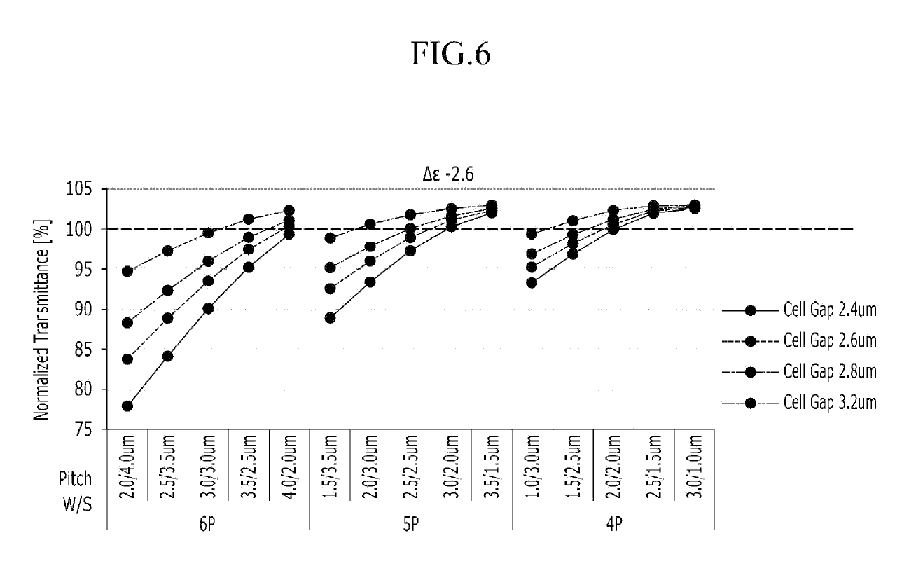

The sum of the width (W) of the micro-branch 194 and the width L of the micro-slit 195 is referred to as the pitch (P) of the micro-branch portion 196. Here, the pitch (P) of the micro-branch portion 196 may be several μm, for example, 4 μm to 6 μm. Further, the width (W) of the micro-branch 194 and the width (L) of the micro-slit 195 are described in more detail with reference to FIGS. 5 and 6.

In accordance with one exemplary embodiment where the first subpixel electrode 191a and the second subpixel electrode 191b respectively have four sub-regions, the first subpixel electrode 191a and the second subpixel electrode 191b may have a first section of the micro-branch portions 196 obliquely extending in the upper-left direction from the horizontal stem portion 192 or the vertical stem portion 193 (e.g., in the respective first sub-regions), while having a second section of the micro-branch portions 196 obliquely extending in the upper-right direction from the horizontal stem portion 192 or the vertical stem portion 193 (e.g., in the respective second sub-regions). Further, a third section of the micro-branch portions 196 may extend in the lower-left direction from the horizontal stem portion 192 or the vertical stem portion 193 (e.g., in the respective third sub-regions), and a fourth section of the micro-branch portions 196 may obliquely extend in the lower-right direction from the horizontal stem portion 192 or the vertical stem portion 193 (e.g., in the respective fourth sub-regions).

Each micro-branch portion 196 may form an angle with the gate line 121 or the horizontal stem portion 192, for example, approximately 40 degrees to 45 degrees. Further, the micro-branch portion 196 included in the first subpixel electrode 191a may have an angle, for example, approximately 40 degrees with the horizontal stem portion 192, while the micro-branch portion 196 included in the second subpixel electrode 191b has an angle, for example, approximately 45 degrees with the horizontal stem portion 192. Further, the micro-branch portions 196 of the two adjacent sub-regions may be orthogonal to each other.

The first subpixel electrode 191a and the second subpixel electrode 191b may be physically and electrically connected with the first drain electrode 175a and the second drain electrode 175b through the contact holes 185a and 185b, respectively, and receive data voltages from the first drain electrode 175a and the second drain electrode 175b. In this case, some of the data voltages applied to the second drain electrode 175b may be divided through the third source electrode 173c, so that the magnitude of the voltage applied to the second subpixel electrode 191b is smaller than the magnitude of the voltage applied to the first subpixel electrode 191a. This is true particularly when the voltage applied to the first subpixel electrode 191a and the second subpixel electrode 191b is positive (+). On the contrary, when the voltage applied to the first subpixel electrode 191a and the second subpixel electrode 191b is negative (−), the voltage applied to the first subpixel electrode 191a is smaller than the voltage applied to the second subpixel electrode 191b.

The areas of the first and second subpixel electrodes 191a and 191b may be determined appropriately. For example, the area of the second subpixel electrode 191b may be as small as the area of the first subpixel electrode 191a and as large as twice the area of the first subpixel electrode 191a.

In accordance with one exemplary embodiment, the auxiliary voltage line 137 may be disposed in a portion corresponding to the data line 171 and include a connection member 138 extending toward the protruding portion 134 of the reference voltage line 131. The connection member 138 may be connected with the third drain electrode 175c through the third contact hole 185c. Since a reference voltage Vcst is applied to the protruding portion 134 of the reference voltage line 131, the reference voltage Vcst has a uniform voltage value, and the reference voltage Vcst is applied to the third thin film transistor through the third drain electrode 175c. As a result, the voltage applied to the second subpixel electrode 191b may be decreased.

Further, a first alignment layer 12 may be formed on the pixel electrode 191.

Hereinafter, the second panel 200 is described.

In accordance with one exemplary embodiment, a light blocking member 220 may be formed on a second substrate 210, which is formed of transparent glass or plastic, for example. The light blocking member 220 is also referred to as a black matrix, and prevents light leakage.

A plurality of color filters 230 may also be formed on the second substrate 210 and the light blocking member 220. Most of the color filters 230 are present within a region surrounded by the light blocking member 220, and may extend along a column of the pixel electrodes 191. Each color filter 230 may display one among the primary colors, such as the three primary colors, i.e., red, green, and blue. However, the colors displayed by the color filter 230 is not limited to the three primary colors, such as red, green, and blue, and the color filter 230 may also display at least one of a cyan-based color, a magenta-based color, a yellow-based color, and a white-based color.

At least one of the light blocking member 220 and the color filter 230 may be formed on the first substrate 110.

An overcoat 250 may be formed on the color filter 230 and the light blocking member 220. The overcoat 250, which is provided to prevent the color filter 230 from being exposed, may be formed of an insulating material, and it may be formed as a flat surface. However, the overcoat 250 may be omitted in one exemplary embodiment.

Further, a common electrode 270 may be formed on the overcoat 250, and the second alignment layer 22 may be formed on the common electrode 270.

Polarizers (not illustrated) may be provided on the external surfaces of the first and second panels 100 and 200, respectively, and the polarization axes of the two polarizers may be orthogonal to each other, and one of the two polarization axes may be parallel to the gate line 121. In the case of a reflective liquid crystal display, one of the two polarizers may be omitted.

The transmittance of the liquid crystal display according to one exemplary embodiment is described with reference to FIGS. 5 and 6.

With respect to FIGS. 5 and 6, the reference conditions are as follows: when the cell gap is 3.2 μm, the pitch of the micro-branch portion is 6 μm, and the dielectric anisotropy (Δε) of the liquid crystal is −3.0. The transmittance of the reference condition is set to be 100%. In the reference condition, the ratio of the width of the micro-branch to the width of the micro-slit configuring the pitch of the micro-branch portion is 1:1.

FIG. 5 is a graph illustrating the relations among the cell gap, the pitch of the micro-branch portion, and the dielectric anisotropy and transmittance of the liquid crystal when the ratio of the width of the micro-branch to the width of the micro-slit configuring a pitch of the micro-branch portion is 1:1.

Referring to FIG. 5, when the dielectric anisotropy (Δε) of the liquid crystal is −2.0, for the conditions that the cell gap is 3.2 μm, and the pitch of the micro-branch portion is 5 μm and 4 μm, the transmittance is the same as that of the reference condition or is improved compared to that of the reference condition.

When the dielectric anisotropy (Δε) of the liquid crystal is −2.6, for the conditions that the pitch of the micro-branch portion is 5 μm, and the cell gap is 3.2 μm and 2.8 μm, the transmittance is the same as that of the reference condition or is improved compared to that of the reference condition.

Further, when the dielectric anisotropy (Δε) of the liquid crystal is −2.6, for the conditions that the pitch of the micro-branch portion is 4 μm, and the cell gap is 3.2 ∥m, 2.8 μm, 2.6 μm, and 2.4 μm, the transmittance is the same as that of the reference condition or is improved compared to that of the reference condition.

When the dielectric anisotropy (Δε) of the liquid crystal is −3.0, for the conditions that the pitch of the micro-branch portion is 5 μm, and the cell gap is 3.2 μm and 2.8 μm, the transmittance is the same as that of the reference condition or is improved compared to that of the reference condition.

Further, when the dielectric anisotropy (Δε) of the liquid crystal is −3.0, for the conditions that the pitch of the micro-branch portion is 4 μm, the cell gap is 3.2 μm, 2.8 μm, 2.6 μm, and 2.4 μm, the transmittance is the same as that of the reference condition or is improved compared to that of the reference condition.

As described above, when the dielectric anisotropy (Δε) of the liquid crystal is −3.0, the cell gap is 3.2 μm, which is the same as that of the reference condition, and the pitch of the micro-branch portion is 5 μm and 4 μm, the transmittance is found to be improved compared to that of the reference condition.

Further, when the cell gap is 3.2 μm, which is the same as that of the reference condition, the pitch of the micro-branch portion is 5 μm and 4 μm, and the dielectric anisotropy (Δε) of the liquid crystal is −3.0, −2.6, and −2.0, the transmittance is found to be improved compared to that of the reference condition.

Further, when the pitch of the micro-branch portion is 6 μm, which is the same as that of the reference condition, the transmittance is found to be decreased compared to that of the reference condition even though the dielectric anisotropy (Δε) of the liquid crystal is increased or the cell gap is decreased compared to that of the reference condition.

Accordingly, it is found that when the dielectric anisotropy of the liquid crystal and the cell gap are the same as those of the reference condition, the transmittance may be improved by decreasing the pitch of the micro-branch portion to be lower than that of the reference condition.

FIG. 6 is a graph illustrating relations among the cell gap, the pitch of the micro-branch portion, and the dielectric anisotropy and transmittance of the liquid crystal according to the width of the micro-branch and the width of the micro-slit configuring a pitch of the micro-branch portion.

In FIG. 6, the target dielectric anisotropy (Δε) of the liquid crystal to compare with the reference condition is −2.6 at 20° C.

Referring to FIG. 6, when the cell gap is 3.2 μm, which is the same as that of the reference condition, and the pitch (P) of the micro-branch portion is 6 μm, for the conditions that the width (W) of the micro-branch is equal to or larger than 3 μm, and the width (S) of the micro-slit is equal to or smaller than 3 μm, the transmittance is equal to that of the reference condition or improved compared to that of the reference condition.

Further, when the cell gap is 3.2 μm, and the pitch (P) of the micro-branch portion is 5 μm, for the conditions that the width (W) of the micro-branch is equal to or larger than 2 μm, and the width (S) of the micro-slit is equal to or smaller than 3 μm, the transmittance is equal to that of the reference condition or improved compared to that of the reference condition.

Further, when the cell gap is 3.2 μm, and the pitch (P) of the micro-branch portion is 4 μm, for the conditions that the width (W) of the micro-branch is equal to or larger than 1.5 μm, and the width (S) of the micro-slit is equal to or smaller than 2.5 μm, the transmittance is equal to that of the reference condition or improved compared to that of the reference condition.

Further, when the cell gap is 2.8 μm, and the pitch (P) of the micro-branch portion is 6 μm, for the conditions that the width (W) of the micro-branch is equal to or larger than 4 μm, and the width (S) of the micro-slit is equal to or smaller than 2 μm, the transmittance is equal to that of the reference condition or improved compared to that of the reference condition.

Further, when the cell gap is 2.8 μm, and the pitch (P) of the micro-branch portion is 5 μm, for the conditions that the width (W) of the micro-branch is equal to or larger than 2.5 μm, and the width (S) of the micro-slit is equal to or smaller than 2.5 μm, the transmittance is equal to that of the reference condition or improved compared to that of the reference condition.

Further, when the cell gap is 2.8 μm, and the pitch (P) of the micro-branch portion is 4 μm, for the conditions that the width (W) of the micro-branch is equal to or larger than 2 μm, and the width (S) of the micro-slit is equal to or smaller than 2 μm, the transmittance is improved compared to that of the reference condition.

Further, when the cell gap is 2.6 μm, and the pitch (P) of the micro-branch portion is 6 μm, for the conditions that the width (W) of the micro-branch is equal to or larger than 4 μm, and the width (S) of the micro-slit is equal to or smaller than 2 μm, the transmittance is equal to that of the reference condition or improved compared to that of the reference condition.

Further, when the cell gap is 2.6 μm, and the pitch (P) of the micro-branch portion is 5 μm, for the conditions that the width (W) of the micro-branch is equal to or larger than 3 μm, and the width (S) of the micro-slit is equal to or smaller than 2 μm, the transmittance is equal to that of the reference condition or improved compared to that of the reference condition.

Further, when the cell gap is 2.6 μm, and the pitch (P) of the micro-branch portion is 4 μm, for the conditions that the width (W) of the micro-branch is equal to or larger than 2 μm, and the width (S) of the micro-slit is equal to or smaller than 2 μm, the transmittance is equal to that of the reference condition or improved compared to that of the reference condition.

Further, when the cell gap is 2.4 μm, and the pitch (P) of the micro-branch portion is 6 μm, for the conditions that the width (W) of the micro-branch is equal to or larger than 4 μm, and the width (S) of the micro-slit is equal to or smaller than 2 μm, the transmittance is equal to that of the reference condition or improved compared to that of the reference condition.

Further, when the cell gap is 2.4 μm, and the pitch (P) of the micro-branch portion is 5 μm, for the conditions that the width (W) of the micro-branch is equal to or larger than 3 μm, and the width (S) of the micro-slit is equal to or smaller than 2 μm, the transmittance is equal to that of the reference condition or improved compared to that of the reference condition.

Further, when the cell gap is 2.4 μm, and the pitch (P) of the micro-branch portion is 4 μm, for the conditions that the width (W) of the micro-branch is equal to or larger than 2 μm, and the width (S) of the micro-slit is equal to or smaller than 2 μm, the transmittance is equal to that of the reference condition or improved compared to that of the reference condition.

As mentioned above, with respect to FIG. 6, the target dielectric anisotropy (Δε) of the liquid crystal to compare with the reference condition is −2.6. The experimental results in FIG. 5 can be further analyzed for the case that the dielectric anisotropy (Δε) of the liquid crystal is −2.6.

In the case where the cell gap is 2.6 μm, and the pitch of the micro-branch portion is 5 μm, when the ratio of the width (W) of the micro-branch and the width (S) of the micro-slit is 1:1 (i.e., the case of FIG. 5), the transmittance is found to be decreased compared to that of the reference condition, but when the width (W) of the micro-branch is equal to or larger than 3 μm, and the width (S) of the micro-slit is equal to or smaller than 2 μm, the transmittance is equal to that of the reference condition or improved compared to that of the reference condition.

That is, it can be found that even when the cell gap and the pitch of the micro-branch portion are not changed, it is possible to improve transmittance by adjusting the width (W) of the micro-branch and the width (S) of the micro-slit. For example, transmittance can be improved by increasing the ratio of the width (W) of the micro-branch to the width (S) of the micro-slit when the pitch (P) of the micro-branch portion is constant. Also, the transmittance of the display can be improved by reducing the pitch of the micro-branch portion.

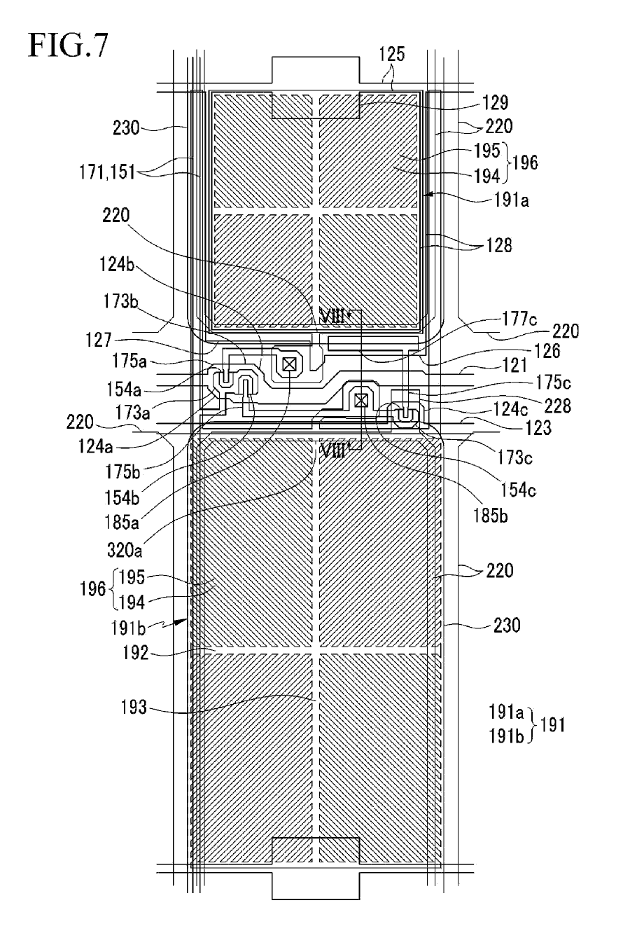

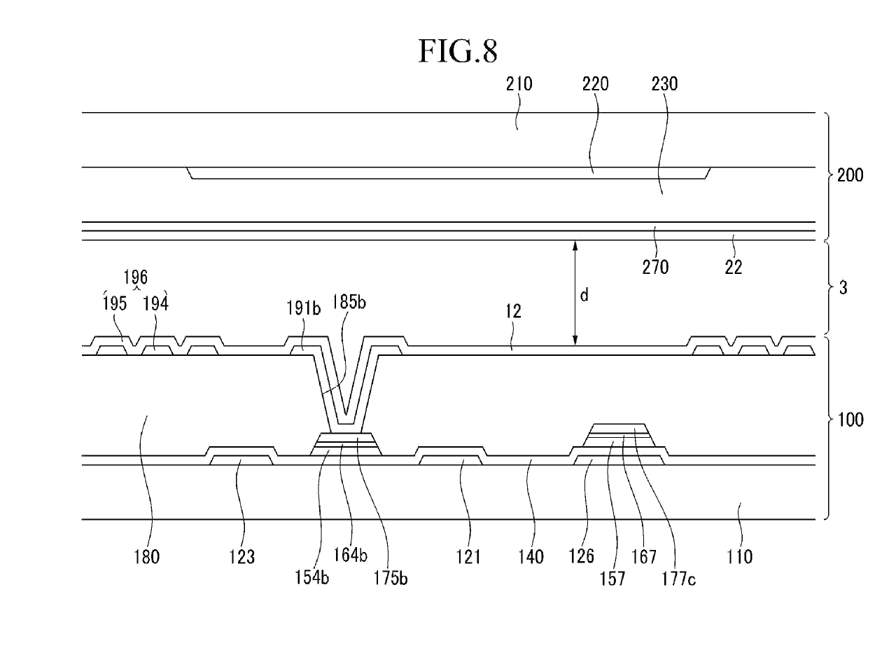

Referring now to FIGS. 7 and 8, a liquid crystal display according to another exemplary embodiment of the present invention is described.

FIG. 7 is a layout view illustrating a liquid crystal display according to another exemplary embodiment of the present invention, and FIG. 8 is a cross-sectional view taken along cut line VIII-VIII of FIG. 7.

Referring to FIGS. 7 and 8, a liquid crystal display according to one exemplary embodiment may include a first panel 100 and a second panel 200, which face each other, and a liquid crystal layer 3 interposed between the first and second panels 100 and 200.

A cell gap d, which represents the thickness of the liquid crystal layer 3 interposed between the first panel 100 and the second panel 200 may be determined appropriately and may be, for example, in a range of 2.4 μm to 3.2 μm.

In accordance with one exemplary embodiment, the liquid crystal layer 3 may include liquid crystal molecules having negative dielectric anisotropy, and may be aligned so that the long axes thereof are vertical to the surfaces of the first and second panels 100 and 200 in the state where there is no electric field.

The dielectric anisotropy (Δε) of the liquid crystal molecule is, for example, −3.0 to −2.0.

Hereinafter, the first panel 100 is described.

In accordance with one exemplary embodiment, a plurality of gate lines 121, a plurality of step-down gate lines 123, and a plurality of storage electrode lines 125 may be formed on the first substrate 110.

The gate lines 121 and the step-down gate lines 123 may mainly extend in the horizontal direction to transfer gate signals. The gate line 121 may be connected or integrally formed with a first gate electrode 124a and a second gate electrode 124b protruding upward and downward, and the step-down gate line 123 may be connected or integrally formed with a third gate electrode 124c protruding upward. The first gate electrode 124a and the second gate electrode 124b may be connected with each other to form one protruding portion in one exemplary embodiment.

In accordance with one exemplary embodiment, the storage electrode line 125 may mainly extend in the horizontal direction to transfer a predetermined voltage, such as a common voltage. The storage electrode line 125 may include a storage electrode 129 protruding upward and downward, a pair of vertical portions 128 extending approximately perpendicularly to the gate line 121 in the downward direction, and a horizontal portion 127 connecting the ends of the pair of vertical portions 128. The horizontal portion 127 may include a capacitance electrode 126 extending in the downward direction.

A gate insulating layer 140 may be formed on the gate line 121, the step-down gate line 123, and the storage electrode line 125.

Further, a plurality of semiconductor stripes 151, which may be formed of amorphous or crystalline silicon, is formed on the gate insulating layer 140. The semiconductor stripe 151 may mainly extend in the vertical direction and may include first and second semiconductors 154a and 154b extending toward the first and second gate electrodes 124a and 124b and connected with each other, and a third semiconductor 154c connected with the second semiconductor 154b. The third semiconductor 154c may extend to form a fourth semiconductor 157.

In accordance with one exemplary embodiment, a plurality of ohmic contact stripes (not illustrated) may be formed on the semiconductor stripe 151. Likewise, a first ohmic contact (not illustrated) may be formed on the first semiconductor 154a, and a second ohmic contact 164b and a third ohmic contact (not illustrated) may be formed on the second semiconductor 154b and the third semiconductor 154c, respectively. The ohmic contact stripe may include a first protruding portion (not illustrated) making a pair with a first ohmic contact island to be disposed on the first protruding portion of the semiconductor, a second protruding portion (not illustrated) making a pair with a second ohmic contact island to be disposed on the second protruding portion of the semiconductor, and a third protruding portion (not illustrated) making a pair with a third ohmic contact island to be disposed on the third protruding portion of the semiconductor. The third ohmic contact may extend to form a fourth ohmic contact 167.

In accordance with one exemplary embodiment, data conductors, which include a plurality of data lines 171, a plurality of first drain electrodes 175a, a plurality of second drain electrodes 175b, and a plurality of third drain electrodes 175c, may be formed on the ohmic contacts 164b and 167.

The data line 171 transfers a data signal, and may mainly extend in the vertical direction to cross the gate line 121 and the step-down gate line 123. Each data line 171 may be connected or integrally formed with a first source electrode 173a and a second source electrode 173b extending toward the first gate electrode 124a and the second gate electrode 124b to form a “W” shape together with the first gate electrode 124a and the second gate electrodes 124b.

In accordance with one exemplary embodiment, each of the first drain electrode 175a, the second drain electrode 175b, and the third drain electrode 175c may be formed to have at least one wide end and one rod-shaped end. The rod-shaped ends of the first drain electrode 175a and the second drain electrode 175b may be partially surrounded by the first source electrode 173a and the second source electrode 173b. One wide end of the second drain electrode 175b may extend again to form the third source electrode 173c bent in a “U” shape. The wide end 177c of the third drain electrode 175c overlaps the capacitance electrode 126 to form a step-down capacitor, and the rod-shaped end thereof is partially surrounded by the third source electrode 173c.

The first, second, and third gate electrodes 124a, 124b, and 124c, the first, second, and third source electrodes 173a, 173b, and 173c, and the first, second, and third drain electrodes 175a, 175b, and 175c form first, second, and third thin film transistors together with the first/second/third semiconductor islands 154a, 154b, and 154c, respectively, and a channel of the thin film transistor is formed in each of the semiconductors 154a, 154b, and 154c between each of the source electrodes 173a, 173b, and 173c, and each of the drain electrodes 175a, 175b, and 175c.

In accordance with one exemplary embodiment, the semiconductor stripe 151 including the semiconductors 154a, 154b, and 154c may have substantially the same plane shape as those of the data conductors 171, 175a, 175b, and 175c, and the ohmic contacts 164b and 167 under the data conductors 171, 175a, 175b, and 175c, except for channel regions between the source electrodes 173a, 173b, and 173c and the drain electrodes 175a, 175b, and 175c. That is, the semiconductor stripe 151 including the semiconductors 154a, 154b, and 154c may have portions that are not covered by the data conductors 171, 175a, 175b, and 175c and are thus exposed, such as areas between the source electrodes 173a, 173b, and 173c and the drain electrodes 175a, 175b, and 175c.

Further, a passivation layer 180 may be formed on the data conductors 171, 175a, 175b, and 175c and the exposed portions of the semiconductors 154a, 154b, and 154c.

The passivation layer 180 may be formed of an organic insulating material, and the surface thereof may be flat. Further, the passivation layer 180 may have a dual layer structure including a lower inorganic layer and an upper organic layer, so that the inorganic layer can prevent the exposed portions of the semiconductors 154a, 154b, and 154c from being damaged while the organic layer contributes to excellent insulation characteristic.

The passivation layer 180 may be provided with a plurality of first contact holes 185a and a plurality of second contact holes 185b, through which a wide end of the first drain electrode 175a and a wide end of the second drain electrode 175b are exposed, respectively.

A plurality of pixel electrodes 191 may be formed on the passivation layer 180.

In accordance with one exemplary embodiment, the first subpixel electrode 191a and the second subpixel electrode 191b may be formed adjacent to each other in the column direction, having a quadrangular shape overall, and may include a cross-shaped stem portion including a horizontal stem portion 192 and a vertical stem portion 193 crossing the horizontal stem portion 192.

Further, the first subpixel electrode 191a and the second subpixel electrode 191b may be divided into multiple sub-regions, such as four sub-regions, by the horizontal stem portion 192 and the vertical stem portion 193, and each sub-region may include a plurality of micro-branch portions 196. Each micro-branch portion 196 may include a micro-branch 194 and a micro-slit 195.

The sum of the width (W) of the micro-branch 194 and the width L of the micro-slit 195 is referred to as pitch (P) of the micro-branch portion 196. The pitch (P) of the micro-branch portion 196, the width (W) of the micro-branch 194, and the width (L) of the micro-slit 195 may be the same as those of the liquid crystal display of FIG. 1.

In accordance with one exemplary embodiment where the first subpixel electrode 191a and the second subpixel electrode 191b respectively have four sub-regions, the first subpixel electrode 191a and the second subpixel electrode 191b may have a first section of the micro-branch portions 196 obliquely extending in the upper-left direction from the horizontal stem portion 192 or the vertical stem portion 193 (e.g., in the respective first sub-regions), while having a second section of the micro-branch portions 196 obliquely extending in the upper-right direction from the horizontal stem portion 192 or the vertical stem portion 193 (e.g., in the respective second sub-regions). Further, a third section of the micro-branch portions 196 may extend in the lower-left direction from the horizontal stem portion 192 or the vertical stem portion 193 (e.g., in the respective third sub-regions), and a fourth section of the micro-branch portions 196 may obliquely extend in the lower-right direction from the horizontal stem portion 192 or the vertical stem portion 193 (e.g., in the respective fourth sub-regions).

Each micro-branch portion 196 may form an angle with the gate line 121 or the horizontal stem portion 192, for example, approximately 40 degrees to 45 degrees. Further, the micro-branch portion 196 included in the first subpixel electrode 191a may have an angle, for example, approximately 40 degrees with the horizontal stem portion 192, while the micro-branch portion 196 included in the second subpixel electrode 191b may have an angle, for example, of approximately 45 degrees with the horizontal stem portion 192. Further, the micro-branch portions 196 of the two adjacent sub-regions may be orthogonal to each other.

The first subpixel electrode 191a and the second subpixel electrode 191b may include outer stem portions surrounding the outer sides thereof, and a vertical portion of the outer stem portion may extend along the data line 171 to prevent capacitive coupling between the data line 171 and the first subpixel electrode 191a and the second subpixel electrode 191b.

The first subpixel electrode 191a and the second subpixel electrode 191b receive data voltages from the first drain electrode 175a and the second drain electrode 175b through the first contact hole 185a and the second contact hole 185b, respectively.

Further, a first alignment layer 12 may be formed on the pixel electrode 191.

Next, the second panel 200 is described.

In accordance with one exemplary embodiment, a light blocking member 220 may be formed on the second substrate 210. The light blocking member 220 prevents light leakage.

A plurality of color filters 230 may also be formed on the second substrate 210 and the light blocking member 220. Most of the color filters 230 are present within a region surrounded by the light blocking member 220, and may extend along a column of the pixel electrodes 191. Each color filter 230 may display one among the primary colors, such as the three primary colors, i.e., red, green, and blue. However, the color displayed by the color filter 230 is not limited to the primary colors, such as red, green, and blue, and the color filter 230 may also display at least one of a cyan-based color, a magenta-based color, a yellow-based color, and a white-based color.

At least one of the light blocking member 220 and the color filter 230 may be formed on the first substrate 110.

Further, a common electrode 270 may be formed on the color filter 230. Also, an overcoat preventing the color filter 230 from being exposed and providing a flat surface may be formed between the common electrode 270 and the color filter 230.

A second alignment layer 22 is formed on the common electrode 270.

Polarizers (not illustrated) may be provided on the external surfaces of the first and second panels 100 and 200, respectively, and the polarization axes of the two polarizers may be orthogonal to each other, and one of the two polarization axes may be parallel to the gate line 121. In the case of a reflective liquid crystal display, one of the two polarizers may be omitted.

The first subpixel electrode 191a and the common electrode 270 may form a first liquid crystal capacitor together with the liquid crystal layer 3 interposed between the first subpixel electrode 191a and the common electrode 270, and the second subpixel electrode 191b and the common electrode 270 may form a second liquid crystal capacitor together with the liquid crystal layer 3 interposed between the second subpixel electrode 191b and the common electrode 270, to maintain the applied voltage even after the first and second thin film transistors are turned off.

In accordance with one exemplary embodiment, the first and second subpixel electrodes 191a and 191b may overlap the storage electrode 129 and the storage electrode line 125 to form first and second storage capacitors, and the first and second storage capacitors can enhance voltage maintenance performance of the first and second liquid crystal capacitors, respectively.

The capacitance electrode 126 and an extended portion 177c of the third drain electrode 175c may overlap each other with the gate insulating layer 140 and the semiconductor layers 157 and 167 therebetween to form a step-down capacitor.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
a first substrate;
a second substrate facing the first substrate;
a thin film transistor disposed on the first substrate;
a pixel electrode connected to the thin film transistor and comprising a first subpixel electrode and a second subpixel electrode that are spaced apart from each other;
a common electrode disposed on the second substrate; and
a liquid crystal layer disposed between the first substrate and the second substrate and comprising liquid crystal molecules having negative dielectric anisotropy,
wherein the first subpixel electrode and the second subpixel electrode comprise a cross-shaped stem portion comprising a horizontal stem portion and a vertical stem portion crossing the horizontal stem portion, and a plurality of micro-branch portions extending from the cross-shaped stem portion,
a thickness of the liquid crystal layer is 2.4 μm to 3.2 μm,
the dielectric anisotropy of the liquid crystal molecule is −3.0 to −2.0, and
a pitch of the micro-branch portion is 4 μm to 6 μm.

2. The liquid crystal display of claim 1, wherein the micro-branch portion comprises a micro-branch and a micro-slit.

3. The liquid crystal display of claim 2, wherein the dielectric anisotropy of the liquid crystal molecule is −2.0.

4. The liquid crystal display of claim 3, wherein a thickness of the liquid crystal layer is 3.2 μm, and the pitch of the micro-branch portion is 5 μm or 4 μm, and
a ratio of a width of the micro-branch to a width of the micro-slit is 1:1.

5. The liquid crystal display of claim 2, wherein the dielectric anisotropy of the liquid crystal molecule is −3.0.

6. The liquid crystal display of claim 5, wherein the pitch of the micro-branch portion is 5 μm, and a thickness of the liquid crystal layer is 3.2 μm or 2.8 μm, and
a ratio of a width of the micro-branch to a width of the micro-slit is 1:1.

7. The liquid crystal display of claim 6, wherein the pitch of the micro-branch portion is 4 μm, and a thickness of the liquid crystal layer is 3.2 μm, 2.8 μm, 2.6 μm, or 2.4 μm, and
a ratio of a width of the micro-branch to a width of the micro-slit is 1:1.

8. The liquid crystal display of claim 2, wherein the dielectric anisotropy of the liquid crystal molecule is −2.6.

9. The liquid crystal display of claim 8, wherein a thickness of the liquid crystal layer is 3.2 μm.

10. The liquid crystal display of claim 9, wherein the pitch of the micro-branch portion is 6 μm, and
a width of the micro-branch is equal to or larger than 3 μm, and a width of the micro-slit is equal to or smaller than 3 μm.

11. The liquid crystal display of claim 9, wherein the pitch of the micro-branch portion is 5 μm, and
a width of the micro-branch is equal to or larger than 2 μm, and a width of the micro-slit is equal to or smaller than 3 μm.

12. The liquid crystal display of claim 9, wherein the pitch of the micro-branch portion is 4 μm, and
a width of the micro-branch is equal to or larger than 1.5 μm, and a width of the micro-slit is equal to or smaller than 2.5 μm.

13. The liquid crystal display of claim 8, wherein a thickness of the liquid crystal layer is 2.8 μm.

14. The liquid crystal display of claim 13, wherein the pitch of the micro-branch portion is 6 μm, and
a width of the micro-branch is equal to or larger than 4 μm, and a width of the micro-slit is equal to or smaller than 2 μm.

15. The liquid crystal display of claim 13, wherein the pitch of the micro-branch portion is 5 μm, and
a width of the micro-branch is equal to or larger than 2.5 μm, and a width of the micro-slit is equal to or smaller than 2.5 μm.

16. The liquid crystal display of claim 13, wherein the pitch of the micro-branch portion is 4 μm, and
a width of the micro-branch is equal to or larger than 2 μm, and a width of the micro-slit is equal to or smaller than 2 μm.

17. The liquid crystal display of claim 8, wherein a thickness of the liquid crystal layer is 2.6 μm.

18. The liquid crystal display of claim 17, wherein the pitch of the micro-branch portion is 6 μm, and
a width of the micro-branch is equal to or larger than 4 μm, and a width of the micro-slit is equal to or smaller than 2 μm.

19. The liquid crystal display of claim 17, wherein the pitch of the micro-branch portion is 5 μm, and
a width of the micro-branch is equal to or larger than 3 μm, and a width of the micro-slit is equal to or smaller than 2 μm.

20. The liquid crystal display of claim 17, wherein the pitch of the micro-branch portion is 4 μm, and
a width of the micro-branch is equal to or larger than 2 μm, and a width of the micro-slit is equal to or smaller than 2 μm.

21. The liquid crystal display of claim 8, wherein a thickness of the liquid crystal layer is 2.4 μm.

22. The liquid crystal display of claim 21, wherein the pitch of the micro-branch portion is 6 μm, and
a width of the micro-branch is equal to or larger than 4 μm, and a width of the micro-slit is equal to or smaller than 2 μm.

23. The liquid crystal display of claim 21, wherein the pitch of the micro-branch portion is 5 μm, and
a width of the micro-branch is equal to or larger than 3 μm, and a width of the micro-slit is equal to or smaller than 2 μm.

24. The liquid crystal display of claim 21, wherein the pitch of the micro-branch portion is 4 μm, and
a width of the micro-branch is equal to or larger than 2 μm, and a width of the micro-slit is equal to or smaller than 2 μm.
